(19) United States
(12) Patent Application Publication
(10) Pub. No.: US 2007/0130098 A1
(43) Pub. Date: Jun. 7, 2007

(54) System and method for predictive analysis for an optimal course of action for desired effects

(76) Inventors: Jeffrey E. Hanneman, Kirkland, WA (US); Will Grannis, Sumner, WA (US); Christopher H. Scott, Kirkland, WA (US)

Correspondence Address: KLEIN, O'NEILL & SINGH, LLP, 43 CORPORATE PARK, SUITE 204, IRVINE, CA, 92606, US

(21) Appl. No.: 11/296,781

(22) Filed: Dec. 7, 2005

(51) Int. Cl. G06N 5/04

(52) U.S. Cl. 706/60

(57) ABSTRACT

Method and system for dynamically predicting effect of plural inputs on an entity is provided. The system includes a simulation module that is coupled to plural modules that provide the plural inputs; and an engine that determines effect of static traits on variable traits, wherein the simulation module provides the user with plural options of how the plural inputs affect the entity.

### BACKGROUND OF THE INVENTION

1. Field of the Invention

The present invention relates to computing systems, and more particularly, to a system and method that performs predictive analysis and provides an optimal course of action for a desired effect.

2. Background

Computing power and computer networks today allow information to be shared quickly and efficiently. Computing systems today can perform complex analysis.

Although electronics and computing systems have progressed they still do not provide a comprehensive, efficient way to measure the effects of dynamic/static variables that are based on real life factors/conditions and provide a user options to change a real life environment so that a desired effect can be experienced.

Conventional simulation models that attempt to simulate real-life conditions have shortcomings. The conventional approach is linear and static. Typically, only a single input is analyzed and no variation in the results is provided. Most conventional heuristic models ignore psychological, cultural or social factors to determine/analyze the interaction between various inputs and the ultimate result.

Therefore, there is a need for a method and system that can simulate real world conditions, receive inputs, dynamically analyze the inputs and provide a user with options so that the user can achieve a desired result.

### SUMMARY OF THE PRESENT INVENTION

In one aspect of the present invention, a system for dynamically predicting effect of plural inputs on an entity is provided. The system includes a simulation module that is coupled to plural modules that provide the plural inputs; and an engine that determines effect of static traits on variable traits, wherein the simulation module provides the user with plural options of how the plural inputs affect the entity.

In another aspect of the present invention, a method for dynamically predicting effect of plural inputs on an entity is provided. The method includes, providing plural inputs to a simulation model; running a simulation operation for analyzing effect of static traits over variable traits; and providing a user with plural options of how the plural inputs affect the entity.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1A shows a block diagram of a computing system, according to one aspect of the present invention;

FIG. 1B shows a block diagram of the internal architecture of the computing system in FIG. 1A;

FIG. 2 is a block diagram of the system, according to one aspect of the present invention;

FIG. 3 is an example of how the system in FIG. 2 can be used; and

FIG. 4 is a process flow diagram for developing and using the system of FIG. 2.

### DETAILED DESCRIPTION OF THE PREFERRED EMBODIMENTS

In one aspect of the present invention, a system and methodology is provided to dynamically model human behavior. Human behaviors under consideration include political, military, economic, social, information, infrastructure, and physical effects of multiple possible actions in any given environment. The system uses a simulation model to help determine optimal courses of action to achieve desired effects with minimal collateral damage or undesired effects.

To facilitate an understanding of the preferred embodiment, the general architecture and operation of a computing system will first be described. The specific architecture and operation of the preferred embodiment will then be described with reference to the general architecture.

Computing System

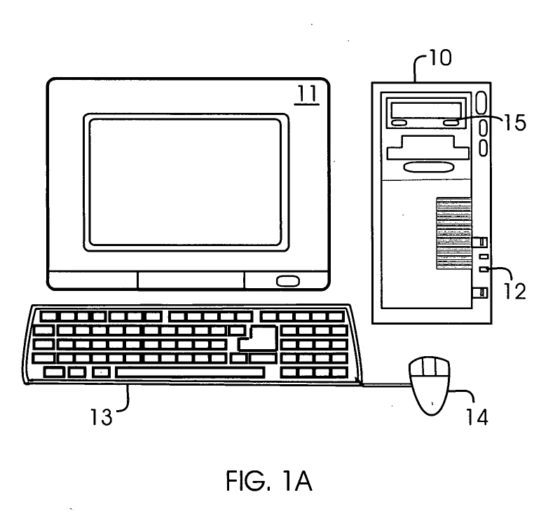

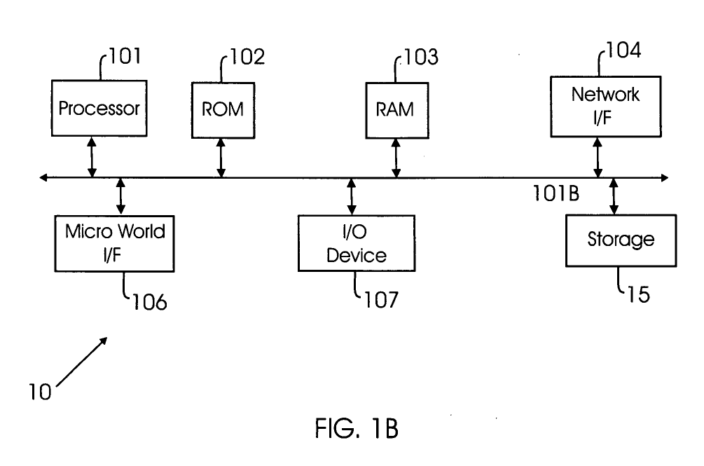

FIG. 1A is a block diagram of a computing system used according to various adaptive aspects of the present invention. The system includes a computer 10 (may also be referred to as “host system 10”) and a monitor 11. Monitor 11 may be a CRT type, a LCD type, or any other type of color or monochrome display. Also provided with computer 10 are a keyboard 13 for entering data and user commands, and a pointing device (for example, a mouse) 14 for processing objects displayed on monitor 11.

Computer 10 includes a computer-readable memory medium such as storage device 15 for storing readable data. Besides other programs, storage device 15 can store application programs including web browsers by which computer 10 connects to the Internet.

A CD-ROM, or CD R/W (read/write) interface (not shown) may also be provided with computer 10 to access application program files, audio files and data files stored on a CD-ROM.

A modem, an integrated services digital network (ISDN) connection, or the like also provides computer 10 with a network (for example, the Internet) connection 12. The network connection 12 allows computer 10 to download data files, audio files, movies, video, application program files and computer-executable process steps embodying the present invention.

It is noteworthy that the present invention is not limited to the FIG. 1A architecture. For example, notebook or laptop computers, handheld devices, set-top boxes or any other system capable of running computer-executable process steps, as described below, may be used to implement the various aspects of the present invention.

FIG. 1B shows a block diagram of a typical host system 10 that includes a central processing unit (“CPU”) (or microprocessor) 101 connected to a system bus 101B. Random access main memory (“RAM”) 103 is coupled to system bus 101B and provides CPU 101 with access to memory storage. When executing program instructions, CPU 101 stores those process steps in RAM 103 and executes the stored process steps out of RAM 103.

Host system 10 connects to a computer network (not shown) via network interface 104 (and through network connection 12). One such network is the Internet that allows host system 10 to download applications, code, documents and others electronic information.

Read only memory (“ROM”) 102 is provided to store invariant instruction sequences such as start-up instruction sequences or basic Input/output operating system (BIOS) sequences.

Input/Output (“I/O”) devices 107, for example, a keyboard, a pointing device (“mouse”), a monitor, a modem and the like are also provided, an example of which is shown in FIG. 1A.

Microworld interface 106 (hardware and/or software) allows processor 101 to interface with Microworld 205.

The process steps, according to one aspect of the present invention may be performed using the Internet. The following provides a brief description of the Internet.

The Internet connects plural computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (XML) as published by W3C Consortium, Version 1, Second Edition, October 2000, ©W3C may also be used. The collection of all such publicly available computer files is known as the World Wide Web (WWW).

The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network or an Internet Service Provider. The web browser may run on any computer connected to the Internet. Currently, various browsers are available of which two prominent browsers are Netscape Navigator and Microsoft Internet Explorer.

The Web Browser receives and sends requests to a web server and acquires information from the WWW. A web server is a program that, upon receipt of a request, sends the requested data to the requesting user. A standard naming convention known as Uniform Resource Locator (“URL”) has been adopted to represent hypermedia links and links to network services. Most files or services can be represented with a URL.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP).

Microworld Knowledge Base/Simulation Environment:

In one aspect of the present invention, a knowledge based tool (also called the “Microworld”) with simulation environment is provided. Plural interactions between people and entities are modeled using cultural, personal, and historical data. The model can be used to predict future interactions within a given environment and produce a desired effect on a certain entity, described below. Learning agents, genetic algorithms, heuristics, fuzzy logic or neural networks are used to perform the analysis/predictions.

In one aspect, inputs/actions include political interactions, military interactions (both kinetic and non-kinetic), monetary exchange and others, as described below.

Instead of following a static path, as most information operation (IO) conventional environmental models, the present invention integrates a set of tools into a network centric environment to model dynamic changes.

In another aspect of the present invention, the system and method is used as a predictive planner for plural aspects of IO (Influence Operations, EW (Electronic Warfare), and CNW (Computer Network Warfare) and others and provides an effects based analysis tool to verify and analyze whether desired effects have been achieved by comparing actual achieved effects versus predicted effects in a network environment.

For example, a conventional static model might predict that implementing a deceptive operation will throw off the adversary and convince them to act in a certain, unchanging way whereas a dynamic model would be able to predict that the same deceptive operation would not be effective if a concurrent action is being taken elsewhere that could jeopardize the deceptive plan, or whether the state of affairs would even view the deceptive action taking place as a priority action. A learning agent could note this, including cultural, geographic, and personnel data, and keep it in store for similar future scenarios to be used with the predictive heuristics to become an adaptive system.

The present system provides an adaptive simulation environment (dynamic Political, Military, Economic, Social, Infrastructure, and Information model world) that receive inputs derived from plural operational conditions and may have previous effects. The output can impact Diplomatic, Information, Military, and Economic (referred to as DIME) actions at a given time.

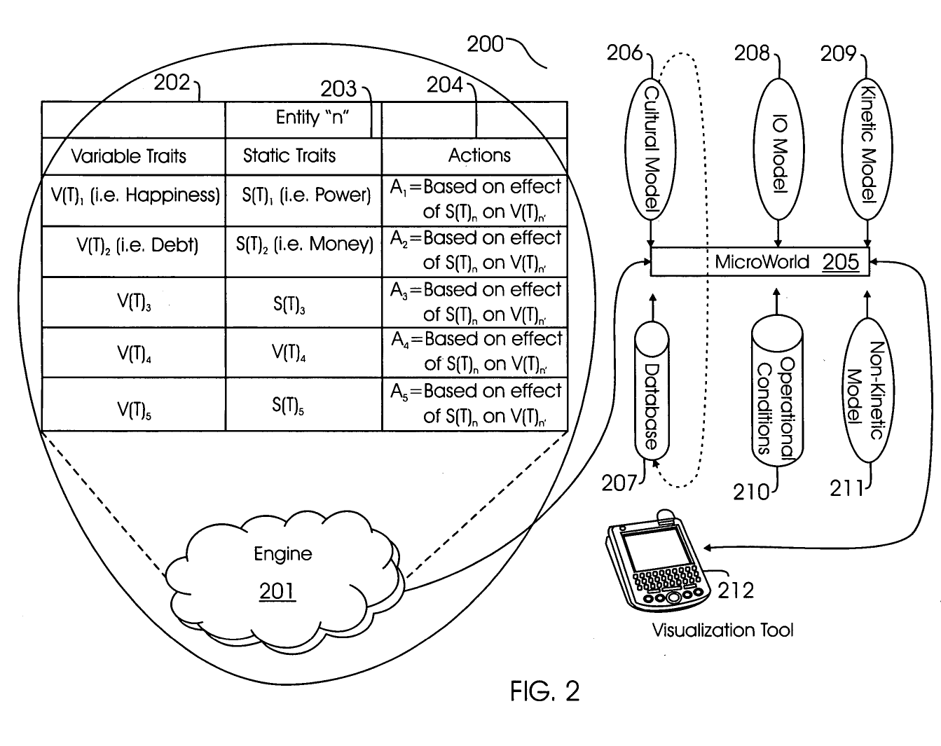

FIG. 2 shows a top-level diagram of system 200, according to one aspect of the present invention. Microworld 205 is a simulation environment that is developed based on inputs from plural models. Microworld 205 may be a software module that executes out of a computing system 10. Microworld 205 can be accessible using a secured Internet connection via a web browser.

It is noteworthy that Microworld 205 may be implemented in hardware as an Application Specific Integrated Circuit (ASICs) that may operate independently or with other hardware/software components.

Microworld 205 can be used in military and civilian situations (described in more detail below). For example, in military application, possible actions could include: firing a missile, invading a city, disabling an enemy computer network, dropping leaflets, communicating over a loudspeaker, or even building a school or other such infrastructure. In civilian applications, possible actions could include: marketing campaigns, political polling techniques, or many other various themes and venues for advertising and sales.

Turning in detail to FIG. 2, Microworld 205 is coupled to plural modules, including cultural model 206, IO model 208, kinetic model 209, non-kinetic model 211, operational conditions 210 and a database 207. The use and affect of these plural modules will now be described.

Cultural model 206 is developed to provide culture specific inputs to Microworld 205. Cultural model 206 inputs allow Microworld 205 to evaluate the interactions of different entities based on certain cultural factors. For example, showing the bottom of one's foot in an Arab culture can be offensive, while it may have no consequence in the American culture. Other examples of cultural model inputs are culture-dependent and adhere to the specific characteristics and ideologies of individual cultures for example, certain gestures in the Indian culture mean “are you hungry?” whereas in the Italian culture they are considered obscene gestures. Microworld 205 considers the cultural factors when evaluating the affect of certain inputs on an entity.

Microworld 205 also interfaces with kinetic model 209 and non-kinetic model 211. Kinetic model 209 provides inputs that are mobile. For example, in a military application, a weapon-target pairing tool provides an input that allows an entity to shoot a specific target and then report the damage. Microworld 205 takes the postulated outcome (i.e., whether the target was destroyed or not) and then evaluate the effect of destroying the target. For example, although the target was destroyed, but if it was a place of worship or was a school, it may have an undesired effect and that is analyzed by Microworld 205.

Non-kinetic model 211 provides non-kinetic input. Examples of such input are dropping leaflets, implementing a computer malfunction, deceptively re-routing supplies, or electronic warfare operations such as jamming a specific frequency. For example, a non-kinetic support tool provides a decision to jam a radio tower disabling communication. Microworld 205 evaluates the effect of the radio jamming beyond frequency detection that confirms that a radio tower has been jammed. For example, by jamming a radio tower, the local population does not get traffic related information and causes traffic jams delaying emergency operation. Microworld 205 will evaluate and consider these plural possibilities.

Microworld 205 also has access to database 207 that provides historical information on the effect of certain events. The historical information is used by Microworld 205 to optimize solutions. Examples of data 207 entries include historical databases of the actions taken and their associated outcomes in past engagements.

IO model 208 provides certain input to Microworld 205. Microworld 205 uses these inputs as a set of references or “rules” based on certain common operating procedures, for example the operating procedures used for Information Operations. For example, for a tactical Psychological Operations (PSYOP) Team to employ their capabilities, they typically require a vehicle of some type, transmission media (such as loudspeakers, megaphone, etc.), approved themes and messages, highly trained IO operators, as well as a target audience. When modeling a tactical PSYOP team within Microworld 205, the integrity of the simulation is maintained because the inputs of the IO model ensure that the appropriate elements of a tactical PSYOP operation are present and represented in conjunction with the inputs generated by other feeder models such as the Cultural Model 206.

Operational conditions 210 provide real time operational conditions. These are inputs from the field and include information about the environment. For example, if Microworld 205 were to determine the effect of bombing a certain target, then operational conditions 210 will include actual target information, including weather, topography, population density and other factors.

Evaluation engine (or engine) 201 also interfaces with Microworld 205. Engine 201 lists plural variable traits 202 and static traits 203. The term trait as used herein is an action/behavior/response by an entity/character/person to certain environmental conditions. The environmental conditions provide a stimulus to the entity/character/person. A static trait 203 in this context is behavior/response that does not change. A variable trait 202 is behavior/response that can vary based on certain environmental conditions. For example, assume that a police officer is a character that is being evaluated. The police officer has a static trait “Respond to Crime”, that he will always respond to a crime scene. The actual response can be a variable trait that may vary based on the circumstances surrounding the crime scene, for example, a response to domestic violence situation is different than a response to an armed robbery.

Engine 201 in column 204 evaluates the action that is based on the effect of a static trait on a variable trait. For example, exploiting knowledge that a person is in debt, or taking action on such knowledge would most likely cause a negative feeling (sadness, worry, guilt, etc.) in the person it affected.

Microworld 205 feeds engine 201 with variable and static trait information that is based on the inputs from the plural models described above. Based on the analysis, an output is provided to a user that the user can view on a visualization tool 212. It is noteworthy that the present invention is not limited to any particular output format or output tool. For example, an output can be received on a monitor, or as an email or as a phone call or in any other form.

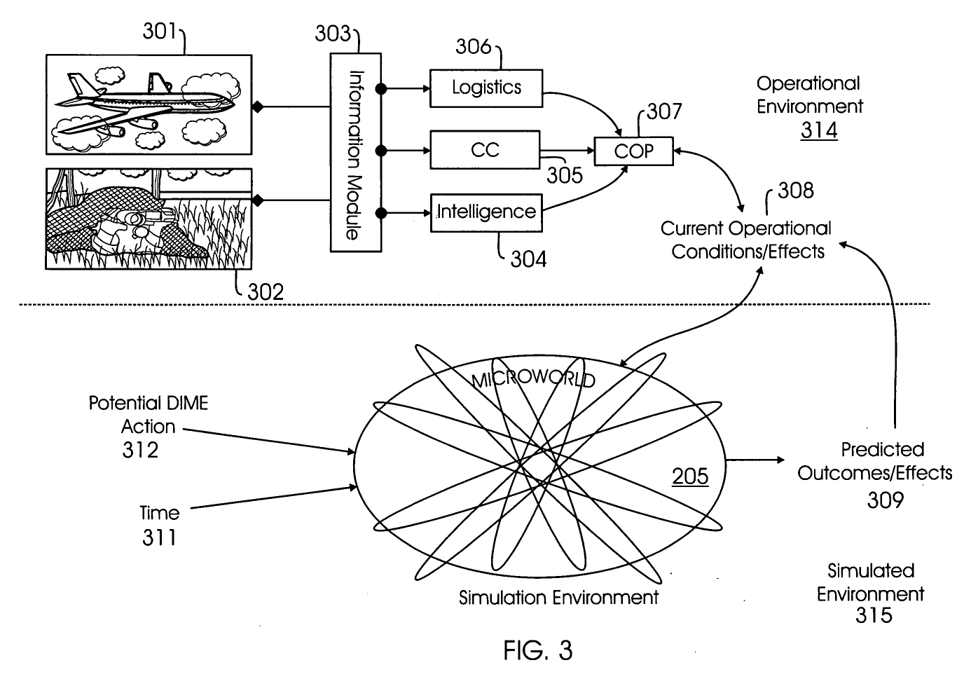

FIG. 3 provides an example of using Microworld 205. The operational environment 314 includes an aircraft 301 and a military tank 302 in a military situation. Information about the two vehicles is collected by information module 303. Information about vehicles 301 and 302 is provided to a logictics center 306, command control (CC) 305 and an intelligence-gathering module 304. It is noteworthy that modules 306, 305 and 304 may be computing systems placed in the same or different locations.

Command operational picture module (COP) 307 then sends out operational conditions 308 to simulation environment 315. Simulation environment 315 includes the Microworld 205 that is dynamically updated.

Microworld 205 receives the operational conditions and provides predicted outcomes/effects 309 based on potential DIME actions 312 and at time 311. As actions occur, the environment changes, thereby causing successive actions to have different effects than they would have previously (with respect to time 311). The predicted outcomes (309) are received by COP 307 that eventually takes action based on the recommendations. This information is then used to monitor and control the behavior of vehicles 301 and 302.

The adaptive aspects of the present invention can be used in military and civilian environments. Microworld 205 architecture allows a user to analyze and predict beneficial courses of action that specific entities should take depending on different parameters.

For example, assume that the primary industry in a small manufacturing town is suffering economic hardship due to the increased presence of overseas suppliers. To avoid going out of business, the main factory in town is faced with either administering significant layoffs or reducing the number of man-hours available. Being a unionized factory, either of these options will cost the company money in either union negotiation or court litigation fees, increasing the funding problems and will cause the morale of the employees to decline.

As a result of these difficulties and the current cost of living in the area, the workers may need to move to a less expensive region. Microworld 205 has the ability to take into account these factors and simulate the interrelations between the dependence on factory jobs and the population of the town. If some people move away to find new work, the price of housing may decline in order to fill the vacancies. In this case, the workers still in the area who have either been laid off or had their hours cut can still afford the cost of living. If no citizens' move away from the area, the price of housing should stay constant, and the remaining employees would either have to find a secondary part time job, find a new job, or have multiple income families. The overseas suppliers and the local housing situation, while seemingly unrelated, are both influences on the livelihood of the city, and need to be considered. This is a scenario in which the overseas suppliers have an effect on both the economy of a small city and the lives of its constituents.

Microworld 205 takes into account the political, military, economic, social, information, infrastructure, and psychological factors of the effects that an overseas supplier may have on a community and will be able to accurately simulate these interactions.

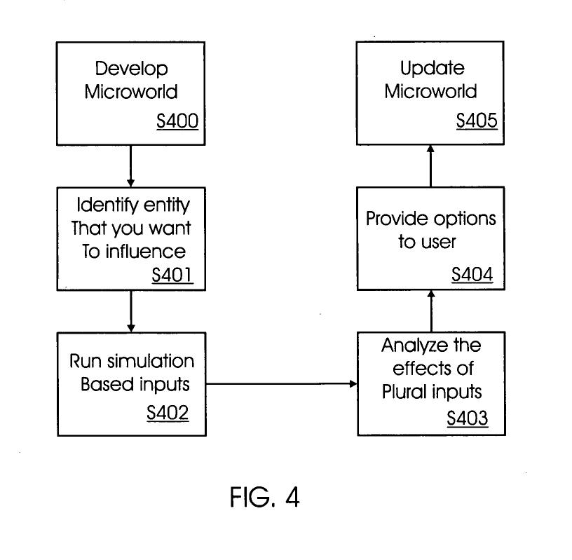

FIG. 4 is a process flow diagram for developing and using Microworld 205, according to one aspect of the present invention. The process starts is step S400 in building knowledge based system. The system is based on inputs from plural models (206, 208, 209, 210 and 211). The system may be stored as a database 207 that is accessible by Microworld 205.

In step S401, a user identifies an entity that the user wants to effect. For example, in a military operation, it may be to attack a target.

In step S402, Microworld 402 based on plural inputs regarding the entity runs a simulation. In step S403, Microworld analyzes the effects of the plural inputs using engine 201.

In step S404, an output is provided to the user and based on the analysis in step S403, Microworld 205 is updated in S405.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

What is claimed is:

1. A system for dynamically predicting effect of plural inputs on an entity, comprising:
a simulation module that is coupled to plural modules that provide the plural inputs; and
an engine that determines effect of static traits on variable traits, wherein the simulation module provides the user with plural options of how the plural inputs effect the entity.

2. The system of claim 1, wherein a cultural model provides inputs that are based on local cultures that may effect the entity.

3. The system of claim 1, wherein a kinetic model provides kinetic input to the simulation module.

4. The system of claim 1, wherein a non-kinetic model provides non-kinetic input to the simulation module.

5. The system of claim 1, wherein real time operational parameters are provided to the simulation module to analyze effect of the operational parameters on the entity.

6. The system of claim 1, wherein the plural options to the user are provided on a visualization tool.

7. The system of claim 1, wherein the entity is a part of a military environment.

8. The system of claim 1, wherein the entity is a part of a civilian environment.

9. A method for dynamically predicting effect of plural inputs on an entity, comprising:
providing plural inputs to a simulation model;
running a simulation operation for analyzing effect of static traits over variable traits; and
providing a user with plural options of how the plural inputs affect the entity.

10. The method of claim 9, wherein a cultural model provides inputs to the simulation model that are based on local cultures that may affect the entity.

11. The method of claim 9, wherein a kinetic model provides kinetic input to the simulation module.

12. The method of claim 9, wherein a non-kinetic model provides non-kinetic input to the simulation module.

13. The method of claim 9, wherein real time operational parameters are provided to the simulation module to analyze effect of the operational parameters on the entity.

14. The method of claim 9, wherein the plural options to the user are provided on a visualization tool.

15. The method of claim 9, wherein the entity is a part of a military environment.

16. The method of claim 9, wherein the entity is a part of a civilian environment.
